(19) United States
(12) Patent Application Publication
(10) Pub. No.: US 2004/0155859 A1
(43) Pub. Date: Aug. 12, 2004

(54) Computer monitor structure

(76) Inventor: Minchy Lee, Taipei (TW)

Correspondence Address: TROXELL LAW OFFICE PLLC, SUITE 1404, 5205 LEESBURG PIKE, FALLS CHURCH, VA, 22041, US

(21) Appl. No.: 10/359,572

(22) Filed: Feb. 7, 2003

(51) Int. Cl. G09G 5/00

(52) U.S. Cl. 345/156

(57) ABSTRACT

A computer monitor comprises a body and a frame; the body sets a display screen, a swivel camera and two speakers; the frame sets a pivoted (or fixed) plate and two center holes encircled with plural hollows at the two ends of the frame. The frame is flexibly fastened to the body by two bolts. A spring inside the body pushing two hemisphere-tipped bars outwards to protrude into a pair of hollows at the frame to wedge the body in a variable angle with the frame. The angle adjustment between the body and the frame, and the position of the plate in relative to the body enable horizontal placing for landscape viewing, vertical placing for portrait viewing, visual angle adjustment, display screen protection, computer-host mounting, wall mounting, and hand-held functions. The invention is applicable to computer monitors as well as computers with displays (LCD PCs, Notebooks, Tablet PCs, etc.).

### BACKGROUND OF THE INVENTION

1. Field of the Invention

The invention relates to a computer monitor structure, especially a structure that enables computers and monitors to achieve horizontal placing for landscape viewing, vertical placing for portrait viewing, visual angle adjustment, display screen protection, wall mounted or computer-host mounted for landscape and portrait viewing, and hand-held functions; moreover, the invention enhances installation stability. The invention is applicable to all kinds of computer monitors (LCD monitors, Plasma monitors, etc.) and computers with displays (LCD PCs, Notebooks, Tablet PCs, etc.), or any other similar structure appliances.

2. Description of the Prior Art

All sorts of computer monitors have been developed ever since computers were widely used.

However, conventional computer monitors were used to connect a horizontal orientation display to a base for placing on desk. This kind of design could simply achieve the object of horizontally placed on desk for landscape viewing, but is unable to perform portrait viewing. In addition, it cannot be computer-host mounted, wall mounted, or hand held, for landscape and portrait viewing.

In view of the above drawbacks, the inventor has devotedly aimed at improving computer monitor structures, thus created this invention.

### BRIEF SUMMARY OF THE INVENTION

In the light of the foregoing description, the main object of the invention is to provide a computer monitor structure which enables two ends of one side of the body to flexibly connect with a frame, so that the monitor body and the frame can integrate with each other at a wide range of angles to enhance the practicability and variation.

Another object of the invention is to provide a computer monitor structure for enabling the body and the frame to wedge with each other and change their relative positions for a variety of combinations applied for desktop placing, computer-host mounting, wall mounting and hand-held for both landscape orientation and portrait orientation viewing; so as to increase the practicability and variation.

To achieve the aforementioned objects, the invention comprises a body and a frame; the said body set with a display screen, a swivel camera and two speakers. The two ends of two sides of the body respectively set a nut. On the brim of each nut at one side of the body sets a position hole and a channel in-between the two position holes for installing two hemisphere-tipped bars and a spring used for pushing the two bars outwards. The frame is U-shaped and there is a plate that is pivoted (or fixed) to the frame. Each end of the frame sets a center hole encircled with plural hollows. The frame is set at the fringe of the body so that the center holes at both ends of the frame align with the nuts at the side of the body having position holes for bolts to flexibly fasten the frame to the body. One of the plural hollows at each end of the frame aligns with the position holes at the body. The spring in the said channel pushes the hemisphere-tipped bars outwards and the hemisphere-tipped ends of the said bars protrude through the position holes into a pair of hollows at the two ends of the frame to wedge the body in an angle with the frame. Unfolding the un-fastened sides of the body and the frame causes the bars protrude into a different pair of hollows to form a different angle, and so the like. The integration and angle adjustment of the body and the frame enable the invention achieving horizontal placing for landscape viewing, vertical placing for portrait viewing and visual angle adjustment. Besides, the plate at the frame serves as the display screen protection cover when it is positioned on the frontage of the body. When it is positioned on the back of the body, it serves as a fixture for mounting the computer monitor onto a computer-host or a wall for enabling horizontal and vertical orientations.

To enable a better understanding of the objectives, structural features and functions of the present invention; the detailed description of the preferred embodiment is followed by the brief description of the drawings as below.

### BRIEF DESCRIPTION OF THE DRAWINGS

FIG. 1 is a perspective view of an embodiment according to the invention.

FIG. 1a is a horizontal cross-section view of FIG. 1.

FIG. 1b is a vertical cross-section view of FIG. 1.

FIG. 2 is a perspective view of the dismantled components of the embodiment according to the invention.

FIG. 3 is a motion illustration of a frame with a pivoted plate.

FIG. 4 is a further motion illustration of FIG. 3.

FIG. 5 is a desktop application example of the embodiment according to the invention. Horizontally placed on desk for landscape viewing.

FIG. 5a is an illustration of visual angle adjustment of FIG. 5.

FIG. 5b is an alternative application of the example in FIG. 5. Vertically placed on desk for portrait viewing.

FIG. 5c is an illustration of visual angle adjustment of FIG. 5b.

FIG. 6 is a computer-host mounted application example of the embodiment according to the invention. Computer-host mounted in horizontal orientation for landscape viewing.

FIG. 6a is the vertical status of the example as shown in FIG. 6. Computer-host mounted in vertical orientation for portrait viewing.

FIG. 6b is a cross-section view of FIG. 6 and FIG. 6a.

FIG. 7 is a wall mounted application example of the embodiment according to the invention. Wall mounted in landscape and portrait orientations.

FIG. 7a is a cross-section view of FIG. 7.

FIG. 8 is an illustration of varying orientations (as shown in FIG. 6, FIG. 6a and FIG. 7) relating to the Center of Gravity.

FIG. 9 is a horizontal desktop application of using a swivel camera.

FIG. 9a is a vertical desktop application of using a swivel camera.

FIG. 10 is a horizontal hand-held application of using a swivel camera.

FIG. 10a is a vertical hand-held application of using a swivel camera.

### DETAILED DESCRIPTION OF THE PREFERRED EMBODIMENT

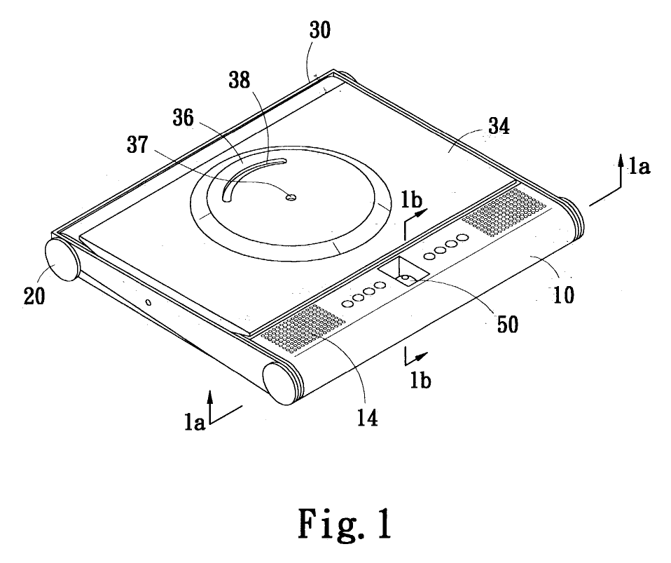

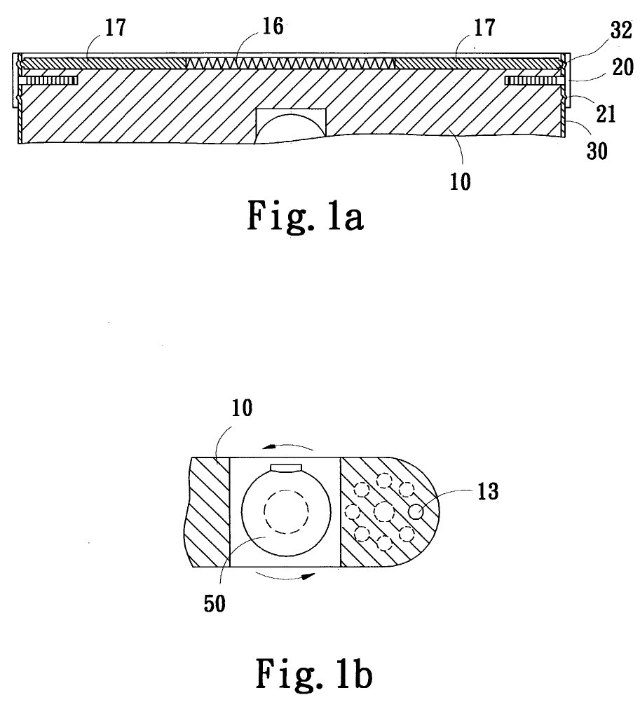

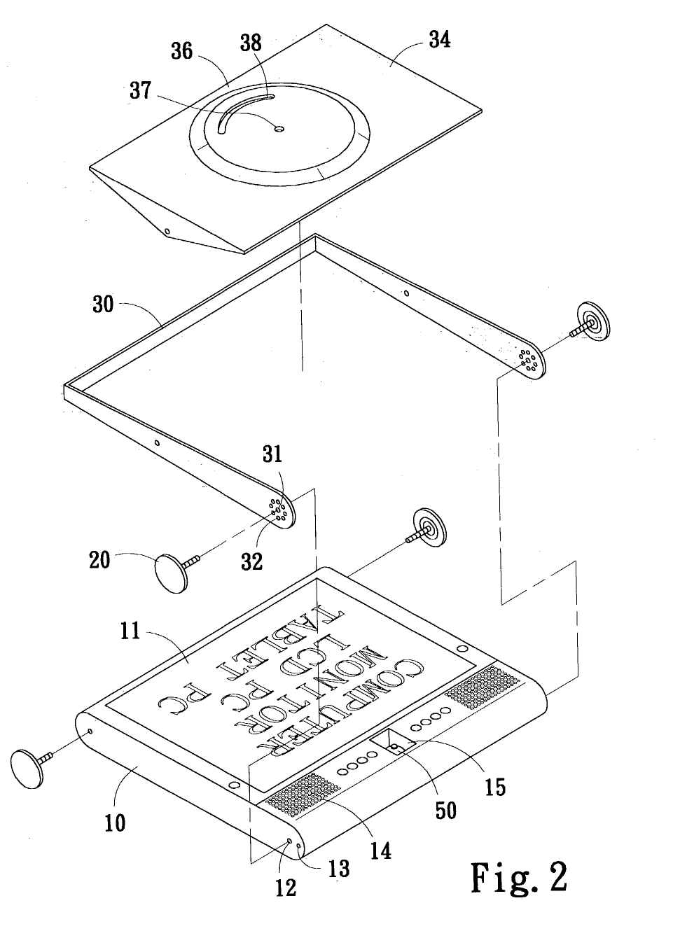

With reference to FIGS. 1 and 2, the invention mainly comprises a body 10, a frame 30 and four bolts 20. The body 10 comprises a display screen 11, a swivel camera 50, two speakers 14 and several controls, moreover, comprises computer components and parts. The two ends of two sides of the body 10 respectively set a nut 12, on the brim of each nut 12 at one side of the body sets a position hole 13 and a channel in-between the two position holes. The body 10 further sets a porthole 15, inside that sets a swivel camera 50 (refer to FIG. 1b). The camera 50 can be swiveled inwards and outwards, and limited degrees of leftwards and rightwards. In addition, the channel in-between the two position holes 13 of the body sets a spring 16 and two hemisphere-tipped bars 17, the spring 16 pushes the hemisphere-tipped ends of the said two bars outwards through the position holes 13, as shown in FIG. 1a.

The frame 30 is U-shaped with a plate 34 set pivotally or fixedly. Moreover, each end of the frame sets a center hole 31 that is encircled with plural hollows 32. The plate 34 sets a protrusion 36 thereon sets an axis hole 37 as a rotation center and an arc-slot 38, the two ends of the said arc-slot meet at right angle with the said hole 37.

Take two bolts 20 and screw them to the two nuts 12 at the body side having no position holes and then, place the frame 30 at the fringe of the body 10, so that the center holes 31 at both ends of the frame 30 align with the nuts 12 at the body side having position holes 13. Take the other two bolts 20 and screw them through the center holes 31 of the frame 30 to the nuts 12 at the body side having position holes. The spring 16 inside the body 10 pushes the hemisphere-tipped bars 17 outwards and the hemisphere-tipped ends of the said bars protrude through the position holes 13 into a pair of hollows 32 at the two ends of the frame 30 to wedge the body with the frame. Thus complete the assembly of the invention (as shown in FIG. 1).

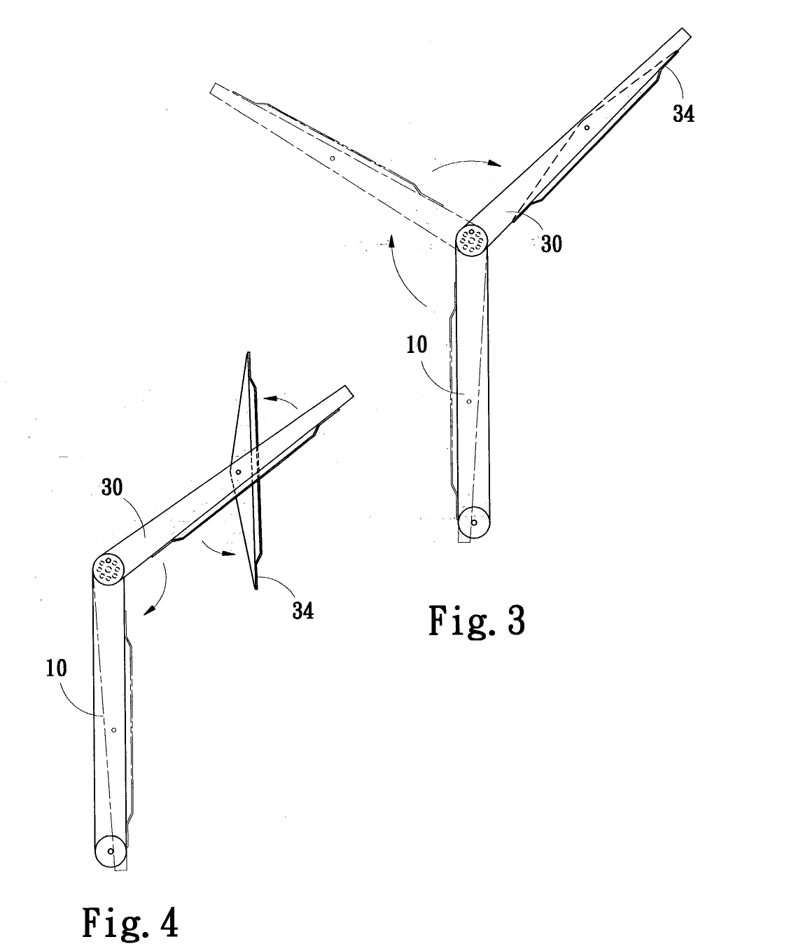

While the frame 30 is folded and the plate 34 is positioned on the frontage of the body 10, the plate 34 functions as a protection cover for the display screen 11 (as also shown in FIG. 1). When unfolding the frame 30 from the body 10, the hemisphere-tipped ends of the bars 17 protrude into another pair of hollows 32 in another angle (as shown in FIG. 3).

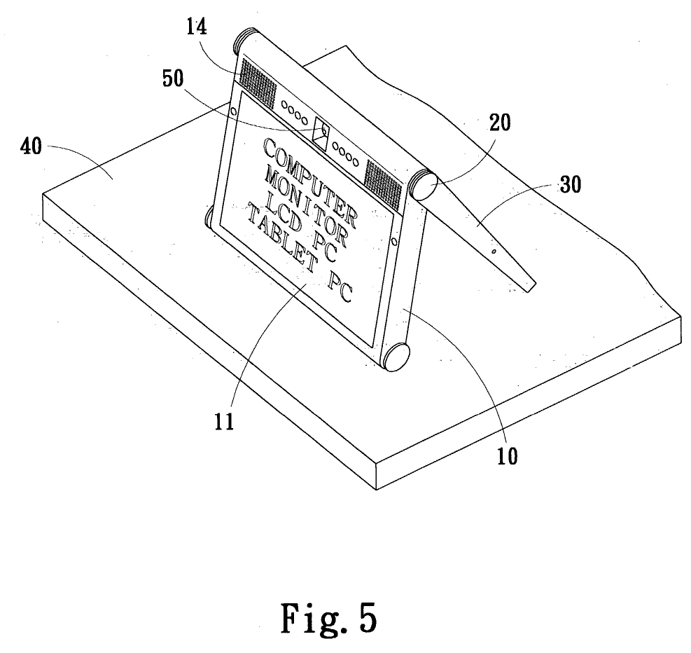

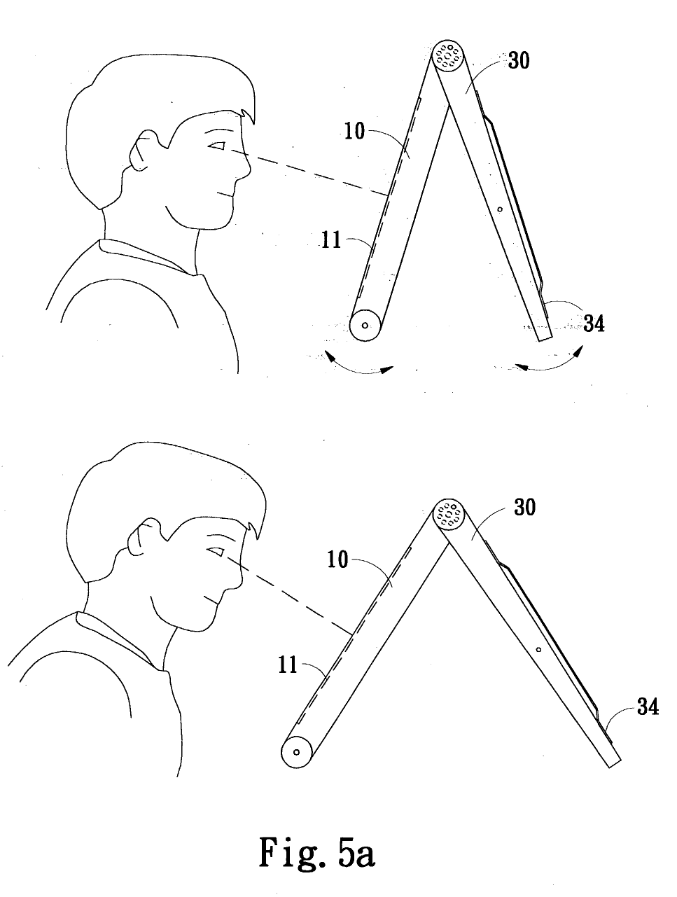

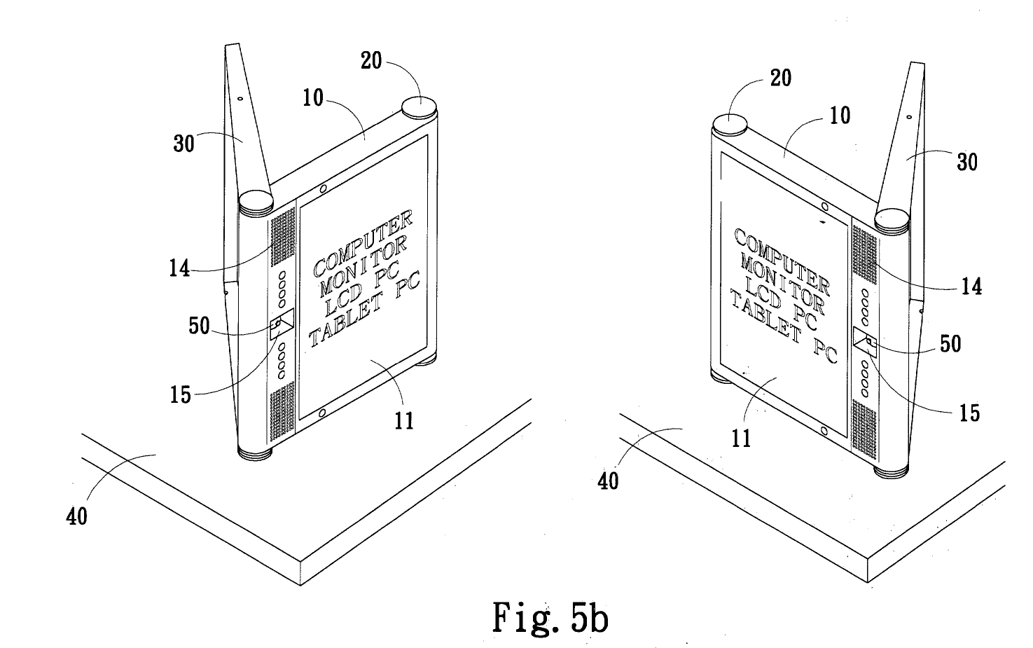

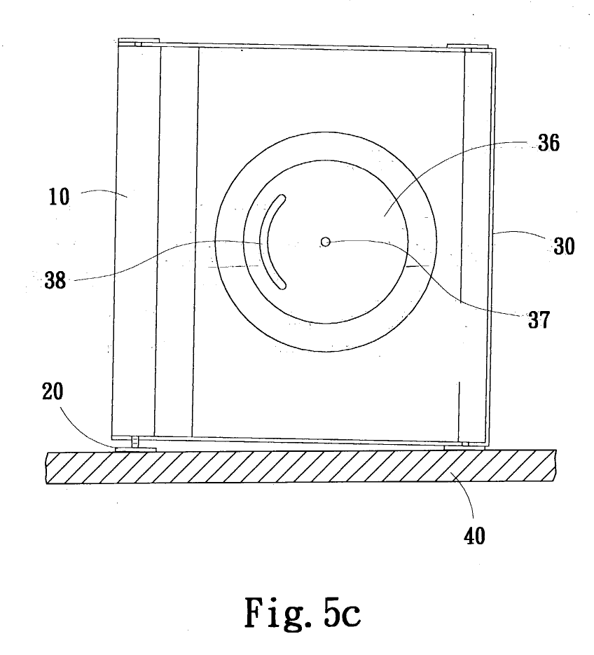

Unfolding the frame 30 to the back of the body 10 to form an included angle, so that the frame 30 functions as an easel for supporting the computer monitor on a desk 40 (as shown in FIG. 5). A user can adjust the visual angle by adjusting the included angle in-between the body 10 and the frame 30 (as shown in FIG. 5a). Besides, the invention can be vertically placed on a desk 40 for portrait viewing (as shown in FIG. 5b). A horizontally placed computer monitor is adequate for viewing charts, games and databases. Nevertheless, a vertically placed computer monitor does not require frequent scrolling up and down in viewing WebPages, E-mails, forms, and A4 or letter-size documents. To adjust visual angles of a vertically placed computer monitor, a user only needs to screw in and out the two bolts 20 at the bottom end of the body 10 (as shown in FIG. 5c).

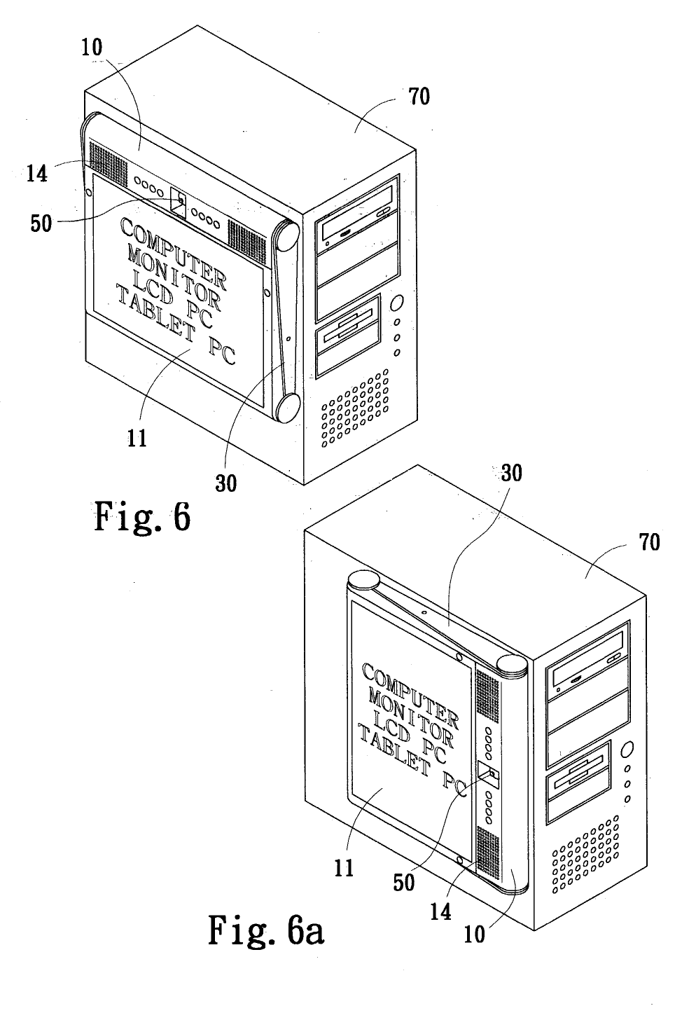

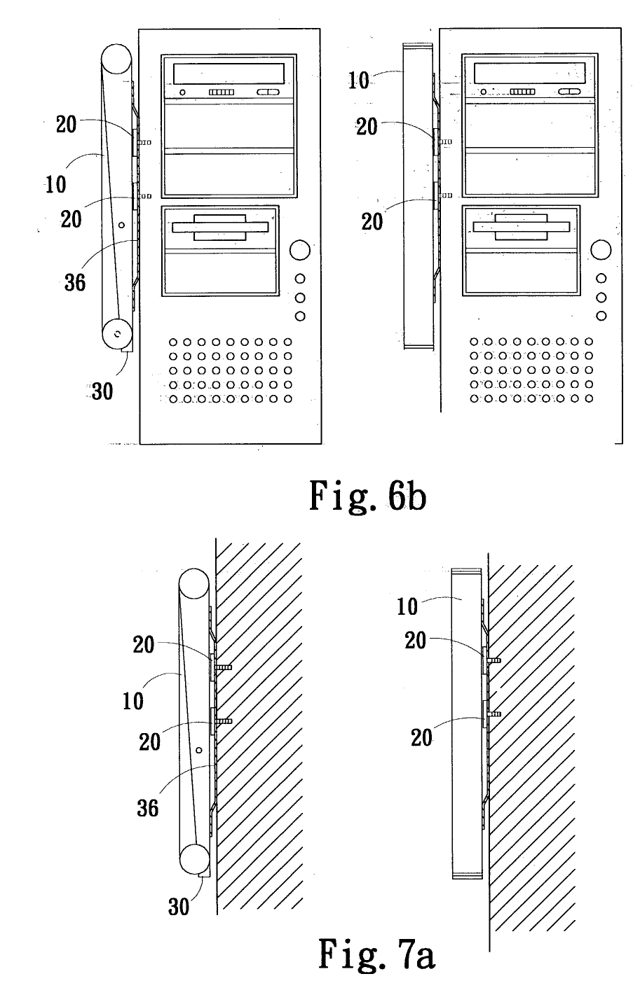

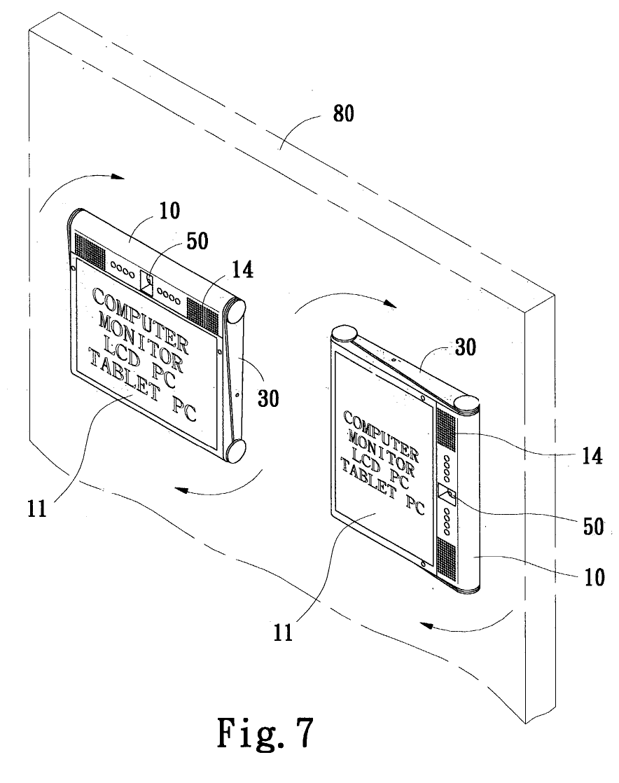

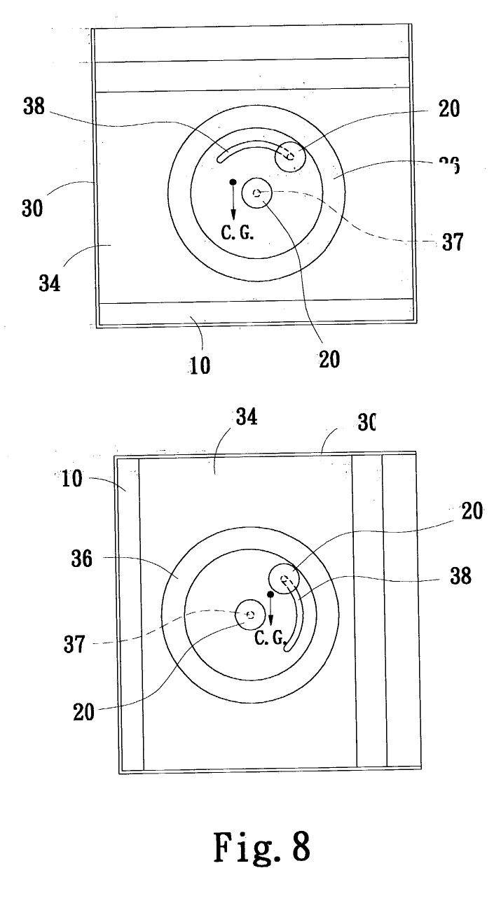

With reference to FIGS. 6-7a, the invention can be mounted on a computer-host 70 or a wall 80. Unfolding the frame 30 from the frontage of the body to the backside of the body and in the meanwhile, rotating the plate 34 for 180° in relative to the frame 30, so as to fold the plate 34 on the back of the body 10 to function as a mounting fixture (as shown in FIG. 6 and FIG. 7), then, unscrewing the two bolts 20 at the body side having no position holes and screwing them through the axis hole 37 and the arc-slot 38 of the protrusion 36 onto a computer-host 70 or a wall 80. As shown in FIG. 8, the Center of Gravity at the upper left (or upper right) of the body 10 rotates the computer monitor until one end of the arc-slot 38 rests against the bolt 20 to form horizontal (or vertical) orientation. Rotating the computer monitor toward another orientation, meanwhile the torque direction of the Center of Gravity is changed to drive another end of the arc-slot 38 rests against the bolt 20.

Furthermore, the plate 34, which is originally pivoted to the frame 30, can also be directly fixed to the frame 30. The operating methods of the frame 30 with pivoted plate or with fixed plate are mostly the same except for unfolding the frame from the frontage (or back) of the body and then folding it to the back (or frontage) of the body. To unfold a frame with fixed plate from the frontage of the body and then fold it to the back of the body: firstly unscrewing the two bolts 20 at the body side having position holes to separate the frame from the frontage of the body, then placing the frame with fixed plate to the back of the body, and then screwing the two bolts 20 through the center holes of the frame to the nuts at the body side having position holes.

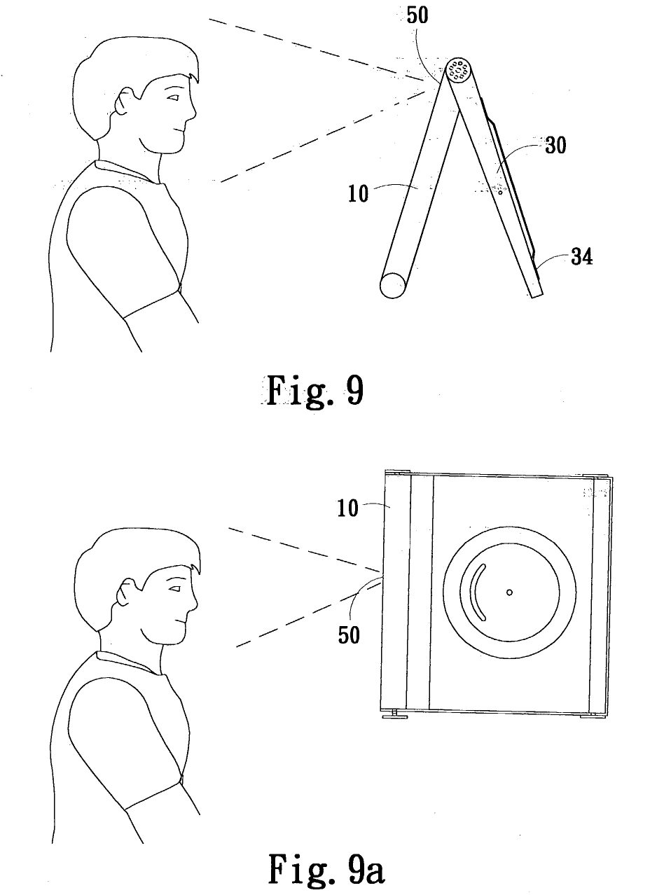

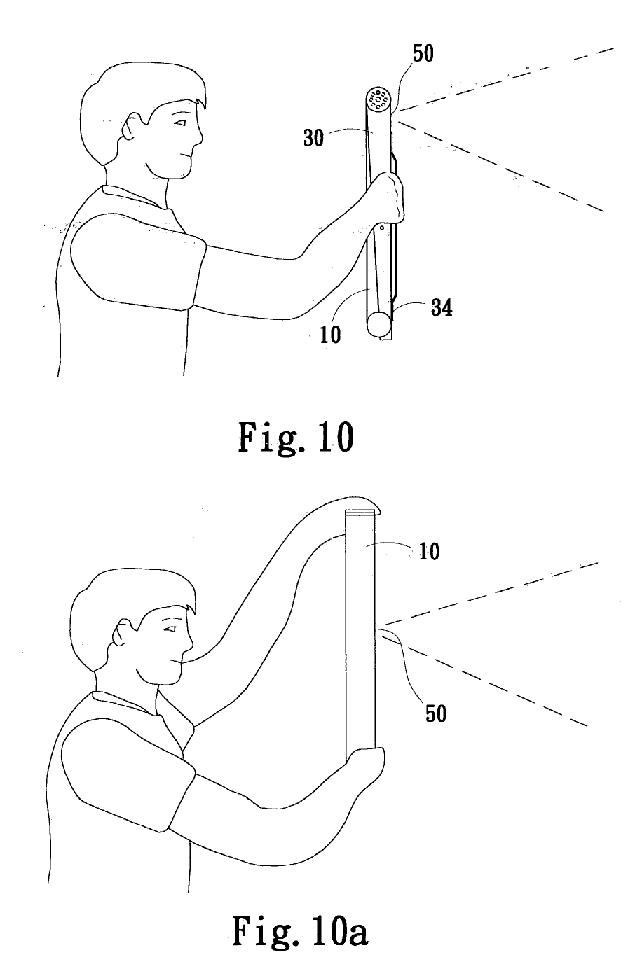

In addition, the camera 50 in the porthole 15 of the body 10 can be swiveled inward towards the user during a video conference; or swiveled outward towards scenery or objectives to function as a digital camera or a video recorder (refer to FIGS. 9 to 10a).

It is known from the above that the computer monitor structure of the invention contains the following advantages:

1. The invention employs simple components to protect the display screen when the computer monitor is not used.

2. The invention only needs the whole computer monitor to be rotated 90° and simple methods to achieve the practicability of switching landscape or portrait orientation and adjusting the visual angle while the invention is placed on desk.

3. The invention employs simple mechanisms to achieve the practicability of changing horizontal or vertical orientation while being mounted on a computer-host or a wall.

It is of course to be understood that the embodiment described herein is merely illustrative of the principles of the invention and that a wide variety of modifications thereto may be effected by persons skilled in the art without departing from the spirit and scope of the invention as set forth in the following claims.

To sum up, in light of the aforementioned descriptions of the disclosed structure, the invention can achieve the expected objects of the said practicability to provide a computer monitor structure herein.

1. A computer monitor structure comprises:
A body, which sets a nut respectively at the two ends of the two sides;
moreover, on the brim of each nut at one side sets a position hole and a channel in-between the said two position holes for installing two hemisphere-tipped bars and a spring; and
A frame with a plate, which is set at the fringe of the said body, each end of the frame sets a center hole encircled with plural hollows, the center holes at both ends of the frame align with the nuts at the body side having position holes for bolts to flexibly fasten the frame to the body, one of the plural hollows at each end of the frame aligns with the position holes of the body, thus by means of the integration and angle adjustment of the frame and the body, the invention may achieve the objects of horizontal orientation for landscape viewing, vertical orientation for portrait viewing, visual angle adjustment, display screen protection, computer-host mounting, wall mounting and hand-held functions.

2. The computer monitor structure of the invention in accordance with claim 1,
wherein the body further comprises computer components and parts to form a computer with display.

3. The computer monitor structure of the invention in accordance with claim 1,
wherein the plate set to the frame is pivoted.

4. The computer monitor structure of the invention in accordance with claim 1,
wherein the plate set to the frame is fixed.

5. The computer monitor structure of the invention in accordance with claim 1
wherein the plate which is set on the frame, has a protrusion thereon sets an axis hole and an arc-slot having 90° included angle with the said axis hole.

6. The computer monitor structure of the invention in accordance with claim 1,
wherein the two nuts of the body side having no position holes are screwed with two bolts.

7. The computer monitor structure of the invention in accordance with claim 1,
wherein the two bolts on the body side having no position holes can be un-screwed from the body and screwed through the axis hole and one end of the arc-slot of the plate onto a computer-host or a wall, so that the computer monitor can be rotated into landscape or portrait orientation.

8. The computer monitor structure of the invention in accordance with claim 1,
wherein the plural hollows at each end of the frame are set in a circle surrounding the center hole.

9. The computer monitor structure of the invention in accordance with claim 1,
wherein the bars inside the body have smaller radius hemisphere-tipped ends for protruding through the position holes of the body into a pair of hollows at the two ends of the frame to wedge the body in an angle with the frame.

10. The computer monitor structure of the invention in accordance with claim 1,
wherein the body sets a porthole, there inside sets a swivel camera for the purposes of videoconference, photographing, or videotaping.

11. The computer monitor structure of the invention in accordance with claim 1,
wherein the body sets two speakers.
